(19) United States
(12) Patent Application Publication
(10) Pub. No.: US 2008/0252109 A1
(43) Pub. Date: Oct. 16, 2008

(54) Aircraft Passenger Seat

(75) Inventors: Uwe Salzer, Salem (DE); Hartmut Schorg, Schwabisch Hall (DE)

Correspondence Address: POSZ LAW GROUP, PLC, 12040 SOUTH LAKES DRIVE, SUITE 101, RESTON, VA, 20191, US

(73) Assignee: RECARDO Aircraft Seating GmbH & Co. KG

(21) Appl. No.: 10/582,348

(22) PCT Filed: Sep. 25, 2004
(86) PCT No.: PCT/EP04/10797

§ 371 Date: Feb. 22, 2007

(30) Foreign Application Priority Data
Dec. 11, 2003 (DE) 103 58 478.1

(51) Int. Cl. B64D 11/06; B60N 3/00

(52) U.S. Cl. 297/173

(57) ABSTRACT

The invention relates to an aircraft passenger seat comprising components such as a seat part, backrest and at least one console that laterally delimits the seat part and forms an armrest. Said console comprises a receptacle for a tray (9), which has an articulated connection to the console by means of a positioning mechanism (11) and which can be displaced from an unused position, in which it lies flush with the console, into either a partitioning position, in which it is raised from the console and vertically extends the lateral delimitation of the seat part, or from said position into a horizontal position, in which it forms a table top. As the support for the tray (9), the positioning mechanism (11) comprises an arm (17), which is pivotally connected to the console about a first axis (21) and a second axis (27) that forms a right-angle with said first axis. The first axis (21) is fixed in the console and runs horizontally and perpendicularly to the main plane of the console. The tray (9) is displaceably mounted on the associated end of the arm (17) so that it can be shifted in the direction of the second axis (27).

The invention relates to an aircraft passenger seat with seat components such as a seat part, backrest, and at least one console which forms an armrest and which laterally borders the seat part, with a receptacle for a plate which is articulated to the console by way of an positioning mechanism and can be positioned by the latter out of a neutral position recessed in the console and into a partition position which extends the lateral boundary of the seat part up and which has been moved upward out of the console, and out of the partition position into a horizontal position which forms a table surface.

An aircraft passenger seat of this type is already known, see DE 101 32 282 A1. In passenger aircraft with rows of seats in which there are several seats next to each other, there is an effort to make available as large an amount of private space as possible to the passengers sitting next to each other. The possibility of extending a partition out of the console between two adjacent seats contributes significantly to achieving this objective. The plate which is extended up out of the console as the partition forms a type of screen of the seat area relative to the seat area of the adjacent passenger seat. The possibility of using the plate not only as a partition, but after transfer into the horizontal position also as a table surface, permits a weight-saving and space-saving construction by the double use of the plate. To meet these requirements, high demands must be imposed on the configuration of the positioning mechanism, especially with respect to operating reliability and ease of operation.

The object of the invention is to devise an aircraft passenger seat of the type under consideration which meets the requirements to be imposed on the positioning mechanism of the plate to an especially large extent.

In an aircraft passenger seat of the initially mentioned type, this object is achieved as claimed in the invention in that the positioning mechanism as the support for the plate has an arm which is connected to the console to be pivotable around a first axle and a second axle which includes a right angle with it, of which the first axle is configured to be stationary on the console and runs perpendicular to the main plane of the console, and in that the plate is movably supported on the assigned end of the arm for the displacement motion which runs in the direction of the second axle.

The movable support of the plate on one arm which is articulated to the console such that it can execute not only a pivoting motion in the main plane of the console, but in the pivot plane which runs transversely thereto, leads to a construction of the positioning mechanism permitting reliable positioning of the plate in all its desired operating positions with a small number of components.

The construction is especially space-saving when the arm is lengthened on its end assigned to the console by an extension which is articulated to the arm to be pivotable around the second axle and on its other end is connected to the console to be pivotable around the first axle.

The positioning mechanism is made especially simple for the passenger to operate when the arm for the pivoting motion around the first axle is pretensioned by a spring configuration for purposes of extending the plate out of the console and when a controllable locking means is present for detachably fixing the plate in the neutral position.

In an especially space-saving construction, the spring configuration can have a helical torsion spring which generates torque on the extension of the arm and which is located on the first axle.

The locking means can have a movable locking member which is pretensioned by spring force into the blocking position and which can be moved by a cable pull out of the blocking position. It can be actuated by the passenger by means of a control element located on the console.

In order to achieve more complete screening between two adjacent passenger seats, in addition to the plate which is used as a partition and which is connected to the support, there can be a second plate as another partition behind the other plate in the area of the backrest and headrest which can be extended out of the console into a partitioning position which is swiveled up. This second plate can be for example pivotably supported in the console and can be shaped on its edge facing the front plate such that when pivoted out of the console, it approaches or conforms to the facing rear edge of the first plate and thus forms an essentially uninterrupted partition (privacy divider) between the adjacent passenger seats.

The invention will be detailed below using one embodiment shown in the drawings.

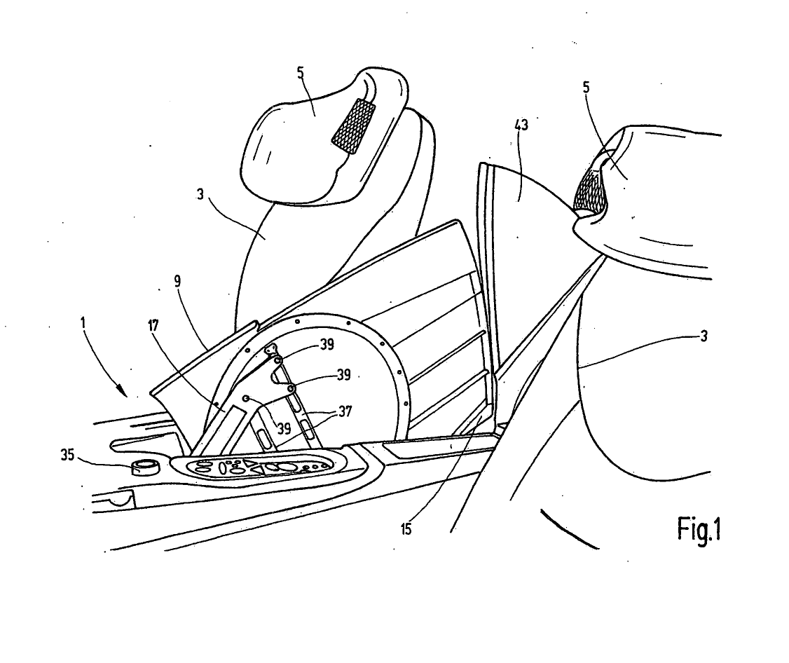

FIG. 1 shows a highly schematically simplified perspective of part of the console between two passenger seats according to one exemplary embodiment of the invention;

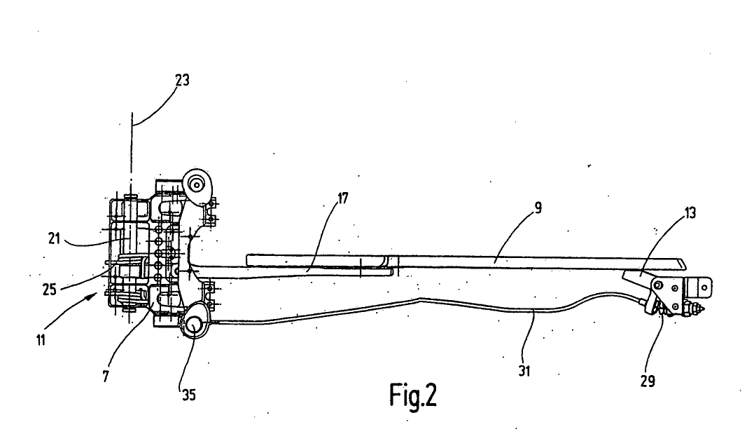

FIG. 2 shows a top view of the support structure of the console of the exemplary embodiment, only one of two plates which can be extended out of the console with the pertinent positioning mechanism being shown and the plate being in its retracted neutral position;

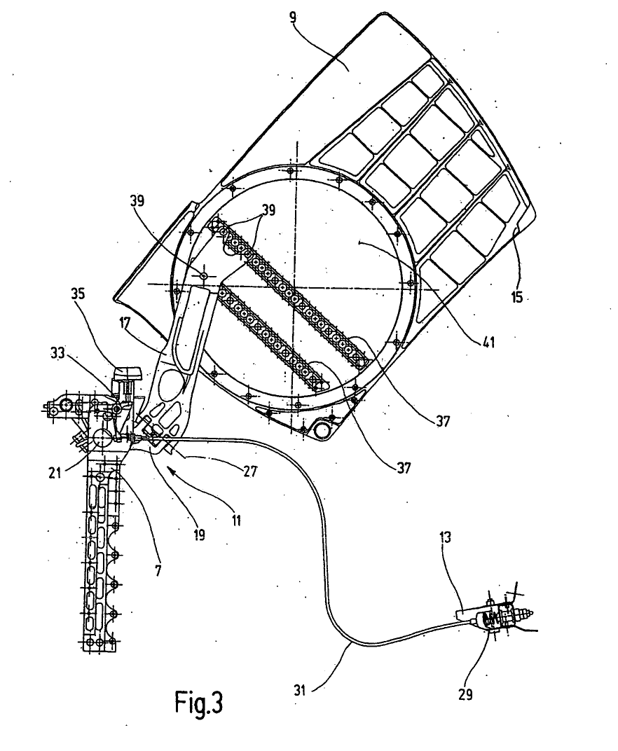

FIG. 3 shows a side view from FIG. 2, the plate being partially extended as far as its partitioning position, and

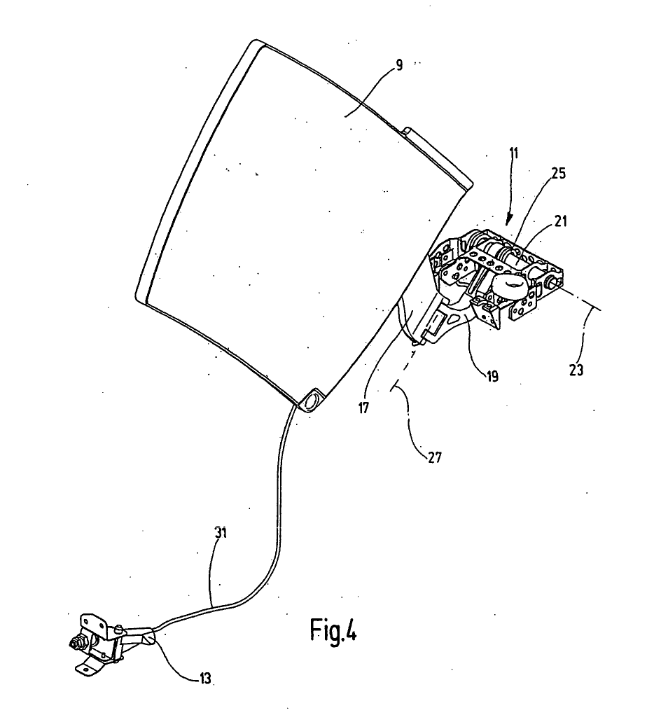

FIG. 4 shows a perspective, oblique partial view of the partially extended plate and its positioning mechanism, looking at the top of the plate which is used as a table surface.

FIG. 1 shows the half of a center console 1 which is facing the viewer between two adjacent aircraft passenger seats, of which only the seat part 3 with the headrest 5 is indicated. FIGS. 2 and 3 shows in a top view and side view a support structure 7 which is installed in the console 1 for the positioning mechanisms of the plates which can be retracted into the console. Of them, only the plate 9 is shown in this figure; it belongs to the aircraft passenger seat nearest the viewer in FIG. 1. In FIGS. 1 and 3 the bottom of this plate 9 and in FIG. 4 the top of this plate 9 are shown. In FIGS. 2 to 4 the positioning mechanism which enables positioning of the plate 9 in different operating positions is designated as a whole as 11. A plate (not shown) which is identical to the plate 9 and which has a positioning mechanism (not shown) corresponding to the positioning mechanism 11 of the illustrated plate 9 which is located likewise on the support structure 7 is assigned to the passenger seat farther away from the viewer in FIG. 1.

FIG. 2 shows the plate 9 in its neutral position and completely retracted into the console in which it is secured by engagement of a movable locking element 13 in a catch notch 15 on the bottom of the plate 9. The positioning mechanism 11 of the plate 9 as a support for the latter has an arm 17 with the end facing away from the plate 9 being lengthened by an extension 19. The end of the extension 19 opposite the arm 17 is mounted on an axle journal 21 to be pivotable around a first axle 23. This axle journal 21 which defines the axle 23 is configured to be stationary in the console 1, running horizontally and perpendicular to the main plane of the console 1.

The axle journal 21 is surrounded by a helical torsion spring 25 which pretensions the extension 19 and thus the arm 17 connected to it for a pivoting motion which moves the plate 9 up out of its retracted neutral position. The connection between the extension 19 and the arm 17 is articulated, the articulated axle shown in FIGS. 3 and 4 by 27 including in space with the first axle 23 a right angle, see FIG. 4. The extension 19 and the arm 17 which is articulated to it are secured against the pivoting motion caused by the torsion spring 25 by means of the aforementioned locking element 13 which interacts with the plate 9, see FIG. 2, and which fixes the plate 9 and thus the arm 17 connected to it in the neutral position retracted into the console. The locking element 13 can be raised against the force of a compression spring 29 out of the blocking position by means of a cable pull 31 which can be actuated by way of an angle lever 33 by means of a button 35 located on the console.

As shown by FIGS. 1 and 3, the plate 9 on its bottom is connected by way of a sliding guide to be able to move in a straight line to the assigned end of the arm 17. On the side of the plate 9, this guide has two guide rails 37 which extend in a straight line in the displacement direction, which lie at a distance next to each other, and in which guide rollers 39 are guided which are supported on the arm 17. So that restricted guidance in a straight line is formed, in one guide rail 37 two rollers 39 are supported, and in the other guide rail 37 there is one roller 39. The guide rails 37 are profile rails with end edges drawn inward so that a C-like profile shape is formed, by which the rollers 39 are secured against lifting out of the guide rails 37.

As is apparent from FIGS. 1 and 3, the guide rails 37 are located on a turntable 41 which on the bottom of the plate 9 forms a rotary disk so that the plate 9 is connected to the arm 17 both to be able to move and to turn.

In order to move the plate 9 out of the recessed neutral position shown in FIG. 2, the occupant of the aircraft passenger seat presses the button 35 in order to unlock the plate 9 by lifting the locking element 13. As a result of the torque caused by the torsion spring 25, the extension 19 with the arm 17 swivels up into the intermediate position which is shown in FIGS. 1, 3, and 4 and which corresponds to the partition position of the plate 9. In it the plate 9 turns the smooth surface of the plate 9 towards the occupant of the adjacent passenger seat. If the plate 9 is swiveled manually farther up out of this partition position until the second swiveling axle 27 at the connecting point between the arm 17 and the extension 19 has reached at least approximately the horizontal position, the plate 9 can be folded into the horizontal position, in which the surface of the plate 9 can act as a table surface.

For this purpose, the plate 9 can be moved into the optimum position by moving along the guide rails 37 relative to the arm 17, optionally by twisting slightly between the turntable 41 and the plate 9. The rotary support between the turntable 41 and the plate 9 can be provided with slight rotary catching in order to define preferred relative rotary positions.

As is to be seen in FIG. 1, there is another plate 43 behind the plate 9 as an additional partitioning element. This plate 43 can be swiveled out of the console 1 in the area of the backrest 3. FIG. 1 shows the additional plate 43 in the extended position. The additional plate 43 which is pivotably mounted in the console 1 can be pretensioned by means of a suitable power drive, for example a gas compression spring for the extension or swiveling movement, and a control element which is located on the console can be provided as a trigger for the pivoting motion and the configuration can be such that the plate 43 can be reset manually against the extension force. Instead of a control element, there could also be a so-called push-pull lock for the plate 43.

1. Aircraft passenger seat with seat components such as a seat part, backrest (3), and at least one console (1) which forms an armrest and which laterally borders the seat part, with a receptacle for a plate (9) which is articulated to (1) by way of an positioning mechanism (11) and can be positioned by the latter out of a neutral position recessed in the console (1) and into a partition position which extends the lateral boundary of the seat part up and which has been moved upward out of the console (1), and out of the partition position into a horizontal position which forms the table surface, characterized in that the positioning mechanism (11) as the support for the plate (9) has an arm (17) which is connected to the console (1) to be pivotable around a first axle (23) and a second (27) which includes a right angle with it, of which the first axle (23) is configured to be stationary on the console (1) and runs horizontally and perpendicular to the main plane of the console (1), and that the plate (9) is movably supported on the assigned end of the arm (17) for the displacement motion which runs in the direction of the second axle (27).

2. The aircraft passenger seat as claimed in claim 1, wherein the arm (17) is lengthened on its end assigned to the console (1) by an extension (19) which is articulated to the arm (17) to be pivotable around the second axle (27).

3. The aircraft passenger seat as claimed in claim 2, wherein the extension (19) is connected to the console (1) to be pivotable around the first axle (23).

4. The aircraft passenger seat as claimed in claim 1, characterized by a spring configuration (25) which pretensions the arm (17) for a pivoting motion around the first axle (23) for purposes of extending the plate (9) out of the console (1), and by a controllable locking means (13, 31, 33, 35) for detachable fixing of the plate (9) in the neutral position.

5. The aircraft passenger seat as claimed in claim 3, wherein the spring configuration has a helical torsion spring (25) which generates torque on the extension (19) of the arm (27) and which is located on the first axle (23).

6. The aircraft passenger seat as claimed in claim 4, wherein the locking means has a movable locking member (13) which is pretensioned by spring force (29) into the blocking position and which can be moved by a cable pull (31) out of the blocking position which can be actuated by a control element (35) located on the console (1).

7. The aircraft passenger seat as claimed in claim 1, wherein the movable support of the plate (9) on the end of the arm (17) is formed by two straight guide rails (37) which are located on the plate (9) and which run at a mutual distance from each other in the displacement direction, and by guide bodies (39) which are guided in the guide rails (37) and are located on the arm (17), of which at least in one guide rail (37) there are two configured at a distance from each other.

8. The aircraft passenger seat as claimed in claim 7, wherein the guide bodies on the arm (17) are guide rollers (39) and the guide rails on the plate (9) are profile strips (39), the profiled shape of which rigidly guides the guide rollers (39) in the displacement direction and secures them against lifting out of the guide rails (37).

9. The aircraft passenger seat as claimed in claim 8, wherein the guide rails (37) are mounted on a turntable (41) which is rotationally connected to the plate (9).

10. The aircraft passenger seat as claimed in claim 1, characterized by a second plate (43) which as an additional partition behind the other plate (9) in the area of the backrest (3) and headrest (5) can be extended out of the console (1) into a partitioning position which is swiveled up.
